(19) United States
(12) Patent Application Publication
(10) Pub. No.: US 2006/0067669 A1
(43) Pub. Date: Mar. 30, 2006

(54) Camera

(75) Inventor: Mitsuhiro Moriya, Minami-Ashigara-Shi (JP)

Correspondence Address: YOUNG & THOMPSON, 745 SOUTH 23RD STREET, 2ND FLOOR, ARLINGTON, VA, 22202, US

(73) Assignee: FUJI PHOTO FILM, CO., LTD, MINAMI-ASHIGARA-SHI (JP)

(21) Appl. No.: 11/237,652

(22) Filed: Sep. 29, 2005

(30) Foreign Application Priority Data
Sep. 29, 2004 (JP) 2004-285270
Mar. 24, 2005 (JP) 2005-087113

(51) Int. Cl. G03B 17/18

(52) U.S. Cl. 396/201

(57) ABSTRACT

A lens-fitted photographic film unit is provided with a first photography mode and a second photography mode that are for non-flash photographing. In order to photograph in daylight, the first photography mode is selected by operating a mode selection lever. A mode indicator does not operate in the first photography mode. In order to photograph under overcast sky or in a lighted indoor place, the second photography mode is selected by operating the mode selection lever. The mode indicator lights up when the second photography mode is set, and blinks when a release button is depressed to photograph. By lighting and blinking, the mode indicator informs a user of that the second photography mode is selected and photographing has been performed.

### BACKGROUND OF THE INVENTION

1. Field of the Invention

The present invention relates to a simple camera capable of selecting a plurality of photography modes for different exposure settings.

2. Background Arts

A simple camera having no focusing mechanism or a simplified focusing mechanism has been on the market at a low price. A lens-fitted photographic film unit is also on the market at a low price which has a photographic film preloaded therein at the time of manufacture, and does not require to rewind and remove an exposed photographic film but does only to be handed to a developing laboratory, where the photographic film is developed and photo prints are produced. Some of such a simple camera and a lens-fitted photographic film unit have a flash device incorporated therein for photographing in a dark place such as an indoor place or at nighttime.

There also is a lens-fitted photographic film unit of mode changeover type capable of photographing in both a bright place such as the outdoors in daylight and a dark place such as an indoor place or at nighttime, by selecting a photography mode based on a photographing condition (disclosed in, for example, Japanese Patent Laid-Open Publication Number 2003-344914). Furthermore, there is a lens-fitted photographic film unit of mode changeover type having a high-speed photographic film preloaded therein for improving a description of a background photographed at nighttime or in the dark place such as the indoor place. “Night & Day”, manufactured and sold by the applicant of the present invention, is known as the photographic film unit of mode changeover type having a high-speed photographic film. In order to photograph with this lens-fitted photographic film unit, a high speed shutter and a small aperture is used as a daylight photographing mode for photographing the bright place, and a low speed shutter and a large aperture is used as a night view/indoor photographing mode for photographing in the dark place.

Since the lens-fitted photographic film unit of mode changeover type having the high-speed photographic film preloaded therein is able to obtain sufficient exposure of both a main subject and the background even indoors or at nighttime, it can appropriately photograph without the flash device in accordance with an environmental condition. Recently suggested is the lens-fitted photographic film unit that has not a flash device and is capable of changing the photographing modes between a daylight mode and night view/indoor mode.

However, it is likely for the user to photograph with those lens-fitted photographic film units, without knowing which photography mode is selected. It thus happens often that the user photographs in daylight while night view/indoor mode is selected, or photographing at nighttime or in the dark place while the daylight mode is selected. As a result, such a problem occurs that the user does not notice that the photographing is failed because of a wrong mode selected in photographing.

In addition, in photographing with the lens-fitted photographic film unit having the flash device, although the user can know the selected photography mode when the flash light is emitted, it is likely for the user to photograph without knowing the selected photography mode when a non-flash photography mode is selected.

### SUMMARY OF THE INVENTION

A main object of the present invention is to provide a camera capable of preventing a user from photographing in a wrong photography mode.

Another object of the present invention is to provide the camera that displays the selected photography mode.

Still another object of the present invention is to provide the camera that informs completion of photographing.

In order to achieve the above objects and other objects, the camera of the present invention comprises a flash device to be changed between ON/OFF status, an exposure control device capable of changing an exposure amount, a mode selection member for selecting one of plural photography modes, and a mode indicator for indicating that a non-flash photography mode is selected. The flash device emits the flash light in the ON state for a flash photographing, and does not emit the flash light in the OFF state for non-flash photographing. In accordance with the selected photography mode, the flash device is changed between the ON/OFF states and the exposure device changes the exposure amount. There are a first photography mode for flash photographing and a second photography mode for non-flash photographing, and the mode indicator blinks on photographing when the second photography mode is selected. Preferably, the mode indicator blinks in conjunction with the shutter operation. The mode indicator lights up while the second photography mode is selected. When there are, for example, three non-flash photography modes, the mode indicator does not blink in the photography mode with the smallest exposure amount, and blinks in different manners in the remaining two photography modes such that the user can distinguish the selected photography mode.

In a preferred embodiment of the present invention, the camera for non-flash photographing has a plurality of photography modes. For the camera having two photography modes, the mode indicator lights up or blinks when the photography mode with the large exposure amount is selected, and does not operate when the photography mode with the small exposure amount is selected. For the camera having three photography modes, the mode indicator lights up or blinks in discernibly different manners in two photography modes. Such discernibly different manners are, for example, difference in number of times of blinking, the number of light source to blink, or the colors of the light source.

According to the camera of the present invention, it is possible to prevent a user from photographing in a wrong photography mode, by informing the user of the selected photography mode before photographing by lighting up or blinking the mode indicator when selecting the photography mode. In addition, since the mode indicator blinks on photographing, it is possible for the user to know that the photographing is performed. Furthermore, the user can recognize the selected photography mode, because the mode indicator blinks differently in accordance with the selected photography mode.

### BRIEF DESCRIPTION OF THE DRAWINGS

One with ordinary skill in the art would easily understand the above-described objects and advantages of the present invention when the following detailed description is read with reference to the drawings attached hereto.

FIG. 1 is an external perspective view illustrating a lens-fitted photographic film unit of a first embodiment when a daylight photography mode is selected;

FIG. 2 is an external perspective view illustrating the lens-fitted photographic film unit of the first embodiment when a night view/indoor photography mode selected;

FIG. 3 is an exploded perspective view illustrating a construction of a unit body;

FIG. 4 is an exploded perspective view illustrating constructions of a stop changeover mechanism, a shutter speed changing mechanism, and a light emitting unit;

FIG. 5 is an explanatory view illustrating the shutter speed changing mechanism in the daylight photography mode;

FIG. 6 is an explanatory view illustrating the shutter speed changing mechanism in the night view/indoor photography mode;

FIG. 7 is an explanatory view illustrating the stop changeover mechanism in the daylight photography mode;

FIG. 8 is an explanatory view the stop changeover mechanism in the night view/indoor photography mode;

FIG. 9 is a circuit diagram illustrating a constitution of a light emitting circuit;

FIG. 10 is an external perspective view of the lens-fitted photographic film unit of the second embodiment;

FIG. 11A to FIG. 11c are explanatory views illustrating positions of a mode selection lever in each photography mode;

FIG. 12 is an exploded perspective view illustrating a construction of the unit body;

FIG. 13 is an exploded perspective view illustrating constructions of a stop changeover mechanism, a shutter speed changing mechanism, and a light emitting unit;

FIG. 14 is an explanatory view illustrating a position of the mode selection lever in the daylight photography mode;

FIG. 15 is an explanatory view illustrating a position of the mode selection lever in the night view/indoor flash photography mode;

FIG. 16 is an explanatory view illustrating a position of the mode selection lever in the night view/indoor non-flash photography mode;

FIG. 17 is a circuit diagram illustrating constitution of a flash circuit and the light emitting circuit;

FIG. 18A to FIG. 18C are explanatory views illustrating a first variant of the first embodiment;

FIG. 19A to FIG. 19C are explanatory views illustrating a second variant of the first embodiment; and

FIG. 20A to FIG. 20C are explanatory views illustrating a third variant of the first embodiment.

### PREFERRED EMBODIMENTS OF THE INVENTION

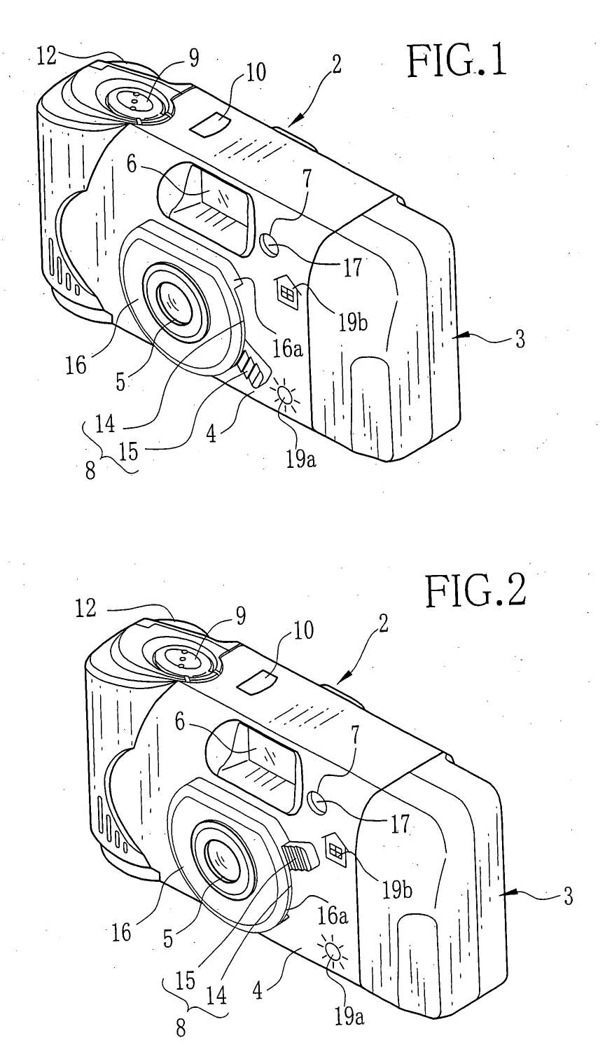

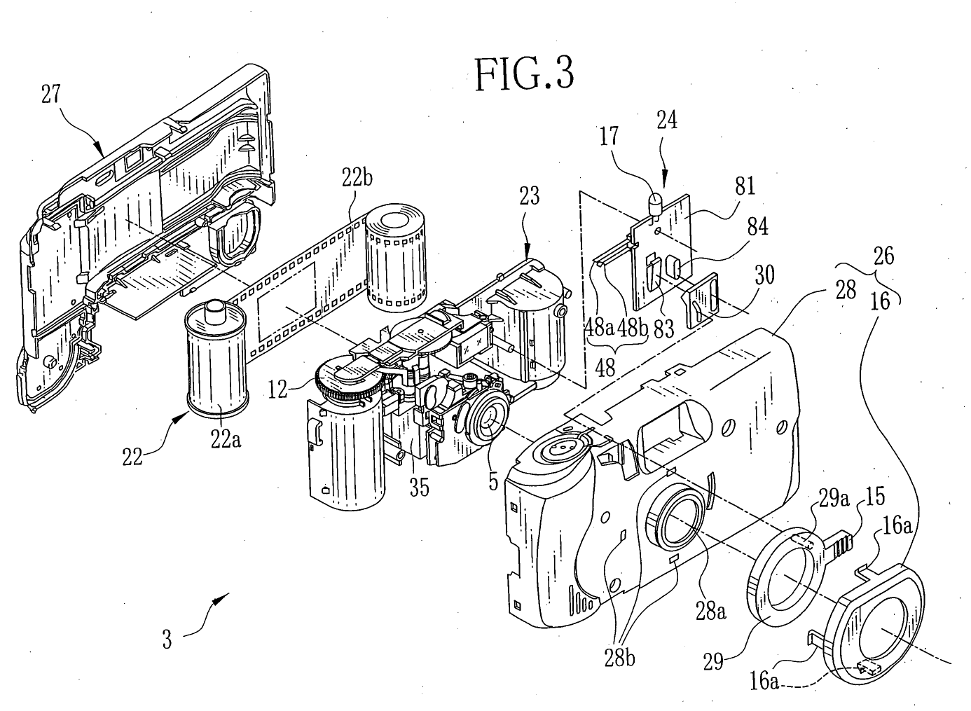

As shown in FIG. 1 and FIG. 2, a lens-fitted photographic film unit 2 comprises a unit body 3 having a variety of photographing mechanisms incorporated therein, a film cartridge 22 (see FIG. 3) preloaded in the unit body 3 at the time of manufacture, and a label 4 attached around the unit body 3. The label 4 is provided with openings for exposing various parts of the unit body 3. The lens-fitted photographic film unit 2 is not provided with a flash device.

The front face of the unit body 3 is provided with a taking lens 5, a viewfinder 6, a mode indicator 7, a photography mode selector 8. The top face of the unit body 3 is provided with a release button 9 and a counter display window 10. A winding wheel 12 is partially exposed at a rear face of the unit body 3.

The photography mode selector 8 comprises an operation slit 14 formed on the front face of the unit body 3, and a mode selection lever 15 protruding from the operation slit 14. The operation slit 14 is formed along a peripheral surface 16a of a decorative panel 16, which is an elliptic panel attached on the front face of the unit body 3. Indicia 19a and 19b are provided in the vicinity of the decorative panel 16. The mode selection lever 15 is provided to swing along the operation slit 14 between a first operating position pointing to the symbol 19a and a second operating position pointing to the symbol 19b.

The lens-fitted photographic film unit 2 selects a daylight photography mode (a first photography mode) for designating a small aperture and a high speed shutter when the mode selection lever 15 is set in the first operating position. The daylight photography mode is suitable for photographing under daylight and used most frequently. When the mode selection lever 15 is set in the second operating position, a night view/indoor photography mode (a second photography mode) is selected for designating a large aperture and a low speed shutter. A lamp 17 provided behind the mode indicator 7 lights up in the second photography mode, and blinks when the shutter release is performed in the second photography mode.

As shown in FIG. 3, the unit body 3 comprises a body base 23 in which a film cartridge 22 of 135 type is preloaded, a light emitting unit 24 mounted on the front face of the body base 23, the mode selection lever 15 for changing the photography mode, and a front cover 26 and a rear cover 27 attached to the front side and the rear side of the body base 23, respectively.

The front cover 26 comprises a front cover body 28 and the decorative panel 16 attached on the front face thereof. The decorative panel 16 is securely fixed with a claw 16 a formed on the rear face thereof engaging with an engaging hole 28b of the front cover body 28. A mode changeover member 29 is integrally formed with the mode selection lever 15 and mounted between the front cover body 28 and the decorative panel 16. The mode changeover member 29 is rotatably fit on a cylindrical rib 28a formed on the front cover body 28, as the front face thereof is supported by the decorative panel 16. A press pin 29a is integrally formed with the rear surface of the mode changeover member 29.

The film cartridge 22 is constituted of the cartridge 22a and a photographic film 22b and loaded in the unit body 3 at the time of manufacture. The photographic film 22b has a film speed of ISO 3200.

A light-shielding tunnel 35 is provided at the center of the front face of the body base 23. Provided in the vicinity of the light-shielding tunnel 35 are a shutter charge mechanism, a shutter release mechanism, a film winding mechanism, a film winding stop mechanism, a frame count mechanism, a stop changeover mechanism, a shutter speed changeover mechanism, an imaging optical system, and a finder optical system.

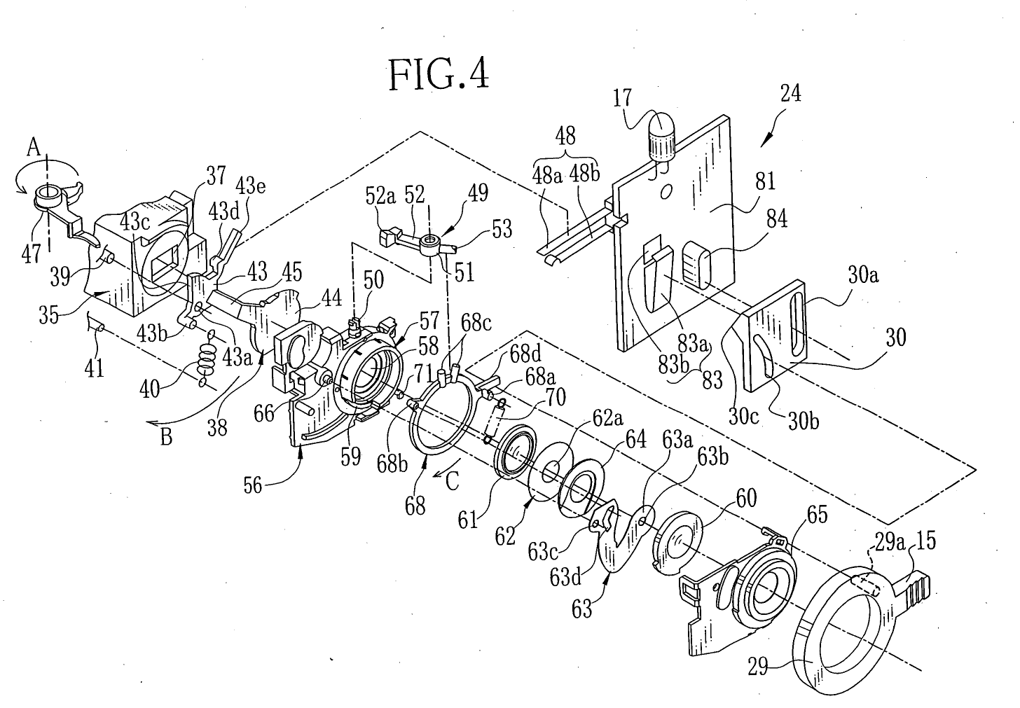

As shown in FIG. 4, an exposure opening 37 in the form of a rectangular hole is formed on the front face of the light-shielding tunnel 35. A pin 39 for rotatably supporting a shutter blade 38 and a pin 41 on which one end of a spring 40 is hanged are provided on a side of the exposure opening 37.

The shutter blade 38 is constituted of a base portion 43 having an opening 43a into which the pin 39 is inserted for rotatably supporting the shutter blade 38, a light-shielding portion 44 disposed in front of the exposure opening 37 for opening and closing the exposure opening 37, and a connecting portion 45 for connecting the base portion 43 and the light-shielding portion 44. The base portion 43 is provided with a pin 43b on which the other end of the spring 40 is hanged, a ledge 43c to be kicked by a shutter drive lever 47, a shutter speed adjusting projection 43d, and a synch projection 43e for activating a sync switch 48 of the light emitting unit 24. The shutter blade 38 is supported in a closing position for closing the exposure opening 37 by the bias of the spring 40.

The shutter drive lever 47 is rotated in a direction opposite to the arrow A to be set in a charging position by the shutter charge mechanism. The shutter drive lever 47 kicks the ledge 43c when rotating in the A direction to a charge release position in response to the depression of the release button 9. The shutter blade 38 kicked by the shutter drive lever 47 rotates in the B direction against the bias by the spring 40, fully opens the exposure opening 37, and then returns to the closing position as biased of the spring 40. When rotating to the opening position, the shutter blade 38 with the sync projection 43e presses an upper metal contact 48a of a synch switch 48 down to contact a lower metal contact 48b. The metal contacts 48a and 48b thus contacts each other and turn on the sync switch 48.

A shaft 50 is formed on top of a lens holder 56, which is for supporting the taking lens 5, to rotatably support a stop lever 49. The stop lever 49 comprises a boss 51 supported by the shaft 50 and two arms 52 and 53 protruding from two sides of the boss 51. A pad 52a is formed at an end of the arm 52.

The stop lever 49 rotates between a high speed shutter position where the pad 52a enters a moving path of the shutter speed adjusting projection 43d of the shutter blade 38, and a low speed shutter position where the pad 52a moves away from the moving path.

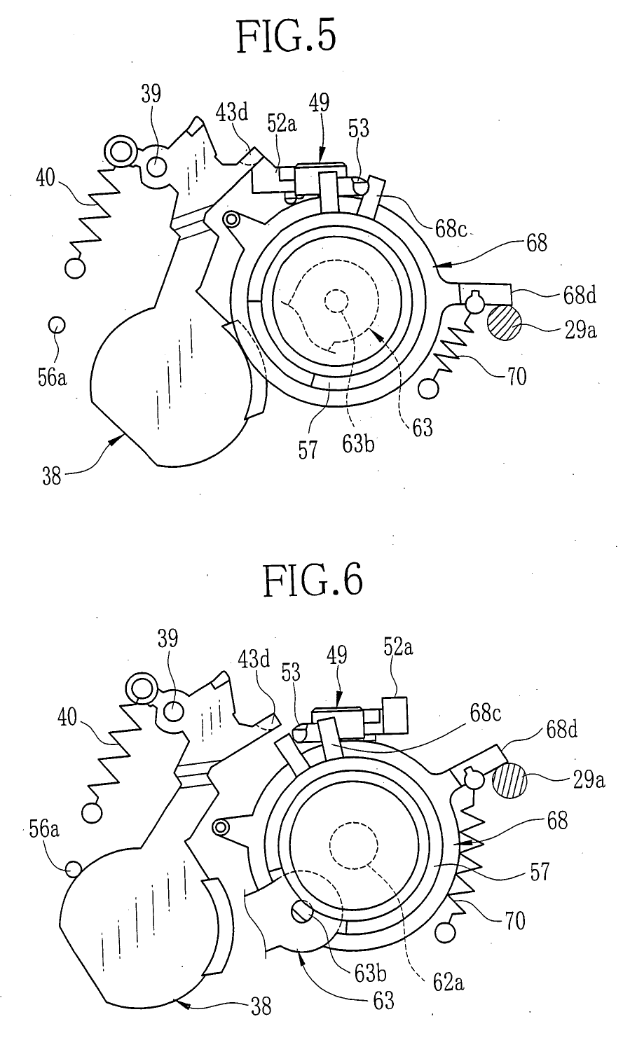

As shown in FIG. 5, when shutter release is performed while the pad 52a of the stop lever 49 is in the high speed shutter position, rotation of the shutter blade 38 is interrupted as the shutter speed adjusting projection 43d of the shutter blade 38 contacts the pad 52a. Accordingly, the shutter blade 38 returns to the closing position in a short time. The shutter speed in this operation is predetermined at, for example, 1/100 sec as a high speed shutter for the first photography mode.

As shown in FIG. 6, when the pad 52a of the stop lever 49 is in the low speed shutter position, the shutter speed adjusting projection 43d rotates without contacting the pad 52a. Accordingly, it takes a long time for the shutter blade 38 to return to the closing position. The shutter speed in this operation is predetermined at, for example, 1/45 sec as a low speed shutter for the second photography mode.

As shown in FIG. 4, the lens holder 56 is attached in front of the light-shielding tunnel 35. A lens barrel 77 in the shape of a cylinder is formed on the center of the front face of the lens holder 56. An opening 58 is formed in the lens barrel 57, and a cutout 59 is formed on the lens barrel 57. A first lens 60 and a second lens 61 are contained in the lens barrel 57. Between the first lens 60 and the second lens 61 disposed are a large aperture stop plate 62, a stop changeover plate 63, and a spacer 64 which keeps a space for the stop changeover plate 63 to enter between the first lens 60 and the large aperture stop plate 62. A retention plate 65 is provided in front of the lens holder 56 to hold the taking lens 5 and a changeover ring 68 put on the peripheral surface of the lens barrel 57.

A stop changeover mechanism comprises the large aperture stop plate 62, the stop changeover plate 63, the spacer 64, and the changeover ring 68. The large aperture stop plate 62 is formed of a circular thin plate and is provided with a large aperture 62a on the center thereof. The large aperture 62a is used in the second photography mode and has a diameter for a diaphragm value at f4.0 in the present embodiment.

The stop changeover plate 63 is formed of a V-shaped thin plate and provided with a small aperture stop portion 63a at one end thereof for covering the large aperture 62a. The small aperture stop portion 63a is provided with a small aperture 63b smaller than the large aperture 62a, on the center thereof. The small aperture 63b is used in the first photography mode and has a diameter for a diaphragm value at f18 in the present embodiment. A hole 63c and a bent slot 63d are formed at the other end of the stop changeover plate 63. A pin 66 formed in the vicinity of the lens barrel 57 is inserted into the hole 63c, and the stop changeover plate 63 is thus supported swingably.

The stop changeover plate 63 swings between a small aperture position for disposing the small aperture stop portion 63a on a photography optical axis, and a large aperture position for moving the small aperture stop portion 63a away from the lens barrel 57 via the cutout 59 for exposing the large aperture 62a.

A changeover ring 68 is rotatably put on the peripheral surface of the lens barrel 57. The changeover ring is provided with a spring hanger pin 68a to hang one end of a spring 70, a link pin 68b inserted into the slot 63d of the stop changeover plate 63, a pair of clamp pins 68c for clamping the arm 53 of the stop lever 49, and a pin 68d protruding from the periphery thereof.

The other end of the spring 70 is hung on a pin 71 formed at the lower front portion of the lens holder 56 to bias the changeover ring 68 in the C direction. The changeover ring 68 biased by the spring 70 is held in a predetermined position by the stop changeover plate 63.

As stated above, the mode changeover member 29 is integrally formed with the mode selection lever 15 and provided with the press pin 29a formed on the rear surface thereof. When the mode selection lever 15 rotates from the first operating position to the second operating position, the press pin 29a pushes up the pin 68d of the changeover ring 68. The changeover ring 68 is thereby rotated in the opposite direction to the C direction against the bias of the spring 70. The press pin 29a contacts the pin 68d and is inserted in a slide slot 30b formed on a press member 30, which is described in detail later.

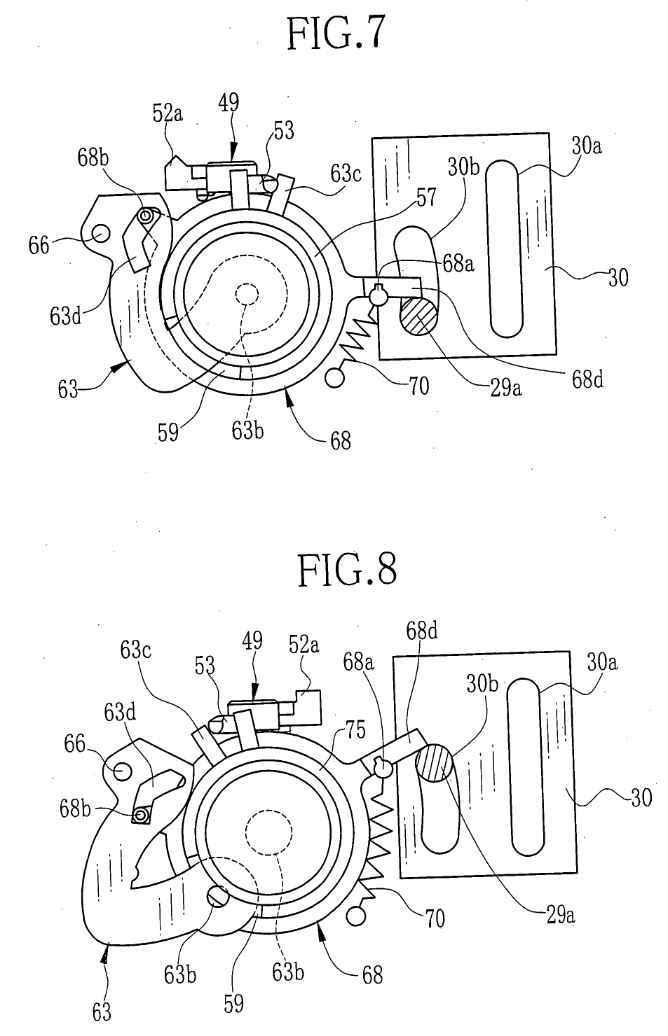

When the mode selection lever 15 is in the first operating position to select the first photography mode as shown in FIG. 7, the changeover ring 68 is maintained in a primary position because the press pin 29a of the mode selection lever 15 does not contact the pin 68d of the changeover ring 68. When the changeover ring 68 is in the primary position, the small aperture stop portion 63a of the stop changing plate 63 is inserted into the lens barrel 57 by the link pin 68b. Accordingly, the small aperture stop portion 63a covers the large aperture 62a. The pair of clamp pins 68c hold the stop lever 49 in the high speed shutter position.

As shown in FIG. 8, when the mode selection lever 15 is moved from the first operating position to the second operating position, the press pin 29a pushes up the pin 56d against the bias of the spring 70 to rotate a changeover ring 68 counterclockwise. The stop changeover plate 63 pressed by the link pin 68b is thereby rotates clockwise, moving the small aperture stop portion 63a away from the photography optical axis. The pair of clamp pins 68c rotate the stop lever 49 and sets it in the low speed shutter position.

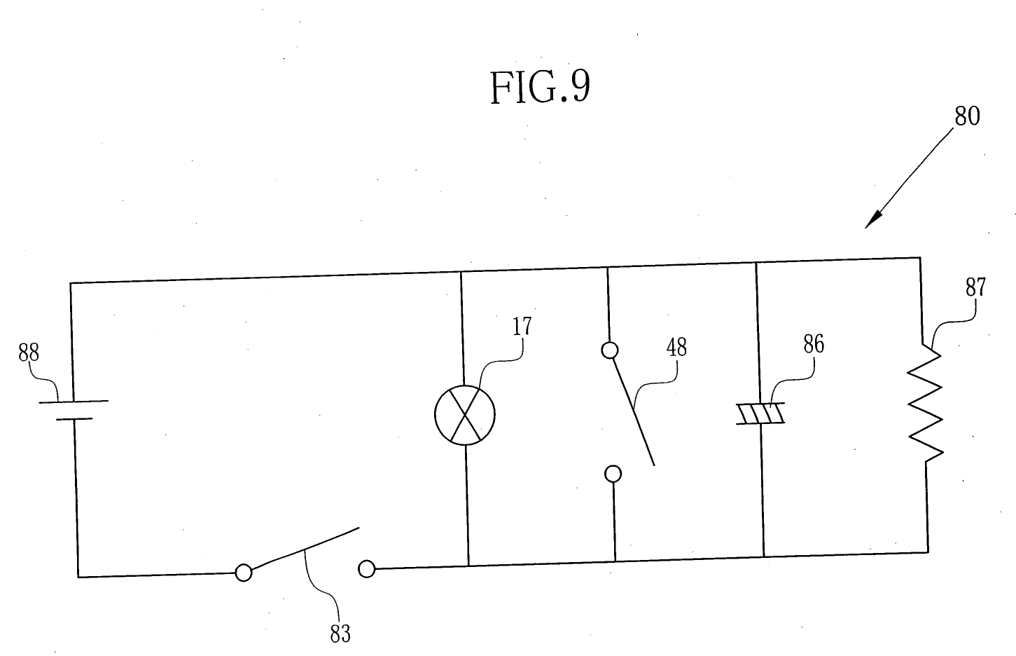

The light emitting unit 24 comprises the lamp 17, a circuit board 81 on which various parts for constituting a light emitting circuit 80 (see FIG. 9) are mounted, a sync switch 48, and a switch 83. A bulb or an LED is employed as the lamp 17.

The circuit board 81 is provided with a fitting projection 84 for fitting in the fitting slot 30a of the press member 30. The fitting slot 30a is formed vertically in the shape of a slit and the press member 30 moves within the fitting slot 30a relatively to the circuit board 81.

A slide slot 30b in the shape of an arc and a press projection 30c is formed on the press member 30. The slide slot 30b engages with the rear portion of the press pin 29a of the mode changeover member 29. Accordingly, when the mode changeover member 29 is in the position for selecting the second photography mode, the press pin 29a pushes up an upper end of the slide slot 30b and moves the press member 30 to the pressing position shown in FIG. 8. The pressing projection 30c of the press member 30 in the pressing position moves a metal plate 83a of the switch 83 to contact a contact portion 83b, and thus the light emitting circuit 80 is turned on. When the mode changeover member 29 is in the position for selecting the first photography mode, the press pin 29a is at the bottom within the slide slot 30b and the press member 30 is in a retreating position (see FIG. 7) away under the switch 83, and the light emitting circuit is thus in an OFF state.

As shown in FIG. 9, the light emitting circuit 80 comprises the lamp 17, the sync switch 48, the switch 83, a capacitor 86, a load resistance 87, and a power source battery 88. When the press member 30 presses and turns the switch 83 on, a current is supplied from the power source battery 88 and charged in the capacitor 86. After the capacitor 86 is fully charged, the current flows to the lamp 17 to illuminate the lamp 17.

Subsequently, when the sync switch 48 is turned on as kicked by the shutter blade 38, the lamp 17 stops lighting up because the capacitor 86 discharges. When the sync switch 48 is turned off, the capacitor 86 is charged again and then the lamp 17 starts lighting up again. Accordingly, the periods of lighting up and turning off of the lamp 17 are controlled by the capacitor 86 and the load resistance 87 for a good visibility.

The following description explains an operation of the above composition. In order to photograph in a bright place such as under daylight, photographing is performed after the mode selection lever 15 is set in the first operating position to select the first photography mode. When the mode selection lever 15 is set in the first operating position, the changeover ring 68 is set in the primary position. Thereby, the stop changeover plate 63 is moved on the photography optical axis and the stop lever 49 is set in the high speed shutter position. Since the switch 83 is not pressed by the press member 30 and the light emitting circuit 81 is in the OFF state, the lamp 17 does not light up. When the shutter release button 9 is depressed in the first photography mode, photographing is performed with the diaphragm value at f18 and the shutter speed at 1/100 sec. Since the lamp 17 does not light up, it is recognizable for the user that the lens-fitted photographic film unit 2 is in the first photography mode (the daylight photography mode).

On the other hand, in order to photograph at nighttime or the indoor place, photographing is performed after the mode selection lever 15 is set in the second operating position to select the second photography mode. When the mode selection lever 15 is moved from the first operating position to the second operating position, the changeover ring 68 rotates as pressed by the press pin 29a of the mode changeover member 29 and to move the stop changeover plate 63 away from the photography optical axis and to rotate the stop lever 49 to the low speed shutter position. In addition, the press pin 29a moves the press member 30 to the pressing position to turn on the switch 83. The lamp 17 in the mode indicator 7 thus lights up after the condenser 86 is charged. Since the lamp 17 lights up, it is recognizable for the user that the lens-fitted photographic film unit 2 is in the second photography mode (the night view/indoor photography mode). When the shutter release button 9 is depressed in the second photography mode, photographing is performed with the diaphragm value at f4.0 and the shutter speed at 1/45 sec. The sync switch 48 is turned on simultaneously with the shutter release and the lamp 17 is turned off. Accordingly, it is recognizable for the user that photographing is performed in the second photography mode. The lamp 17 lights up when the sync switch 48 is turned on again.

Since the camera of the present invention enables the user to select an appropriate photography mode and to know the photographing is performed in the appropriate photography mode, it can be prevented that the user performs photographing without knowing that an inappropriate photography mode has been selected. In addition, since the lamp 17 blinks on the shutter release, it is possible for a subject person to recognize the shutter release.

Note that although the lamp 17 is disposed on the front face of the unit body 3 in the above embodiment, the present invention is not limited in such arrangement. For example, the lamp 17 can be disposed in the finder optical system, such that the photographer can view the light of the lamp 17 while framing and know the selected photography mode.

In the above embodiment the lens-fitted photographic film unit having no flash device is provided with the mode indicator for indicating the photography mode to the photographer or the subject person. However, the present invention is also applicable to the lens-fitted photographic film unit having the flash device and a plurality of photographing mode including the non-flash photography mode, for indicating to the photographer or the subject person that the non-flash photography mode is selected.

The following description explains a lens-fitted photographic film unit having the flash device of the second embodiment that is capable of indicating to the photographer or the subject person that the non-flash photography mode is selected. The components identical with those of the above-described first embodiment are denoted by the same reference numerals, and descriptions thereof are abbreviated.

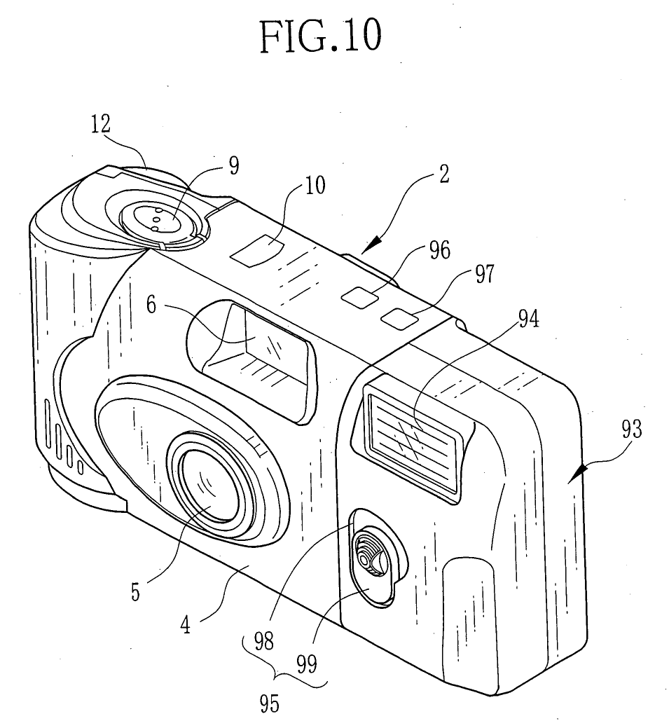

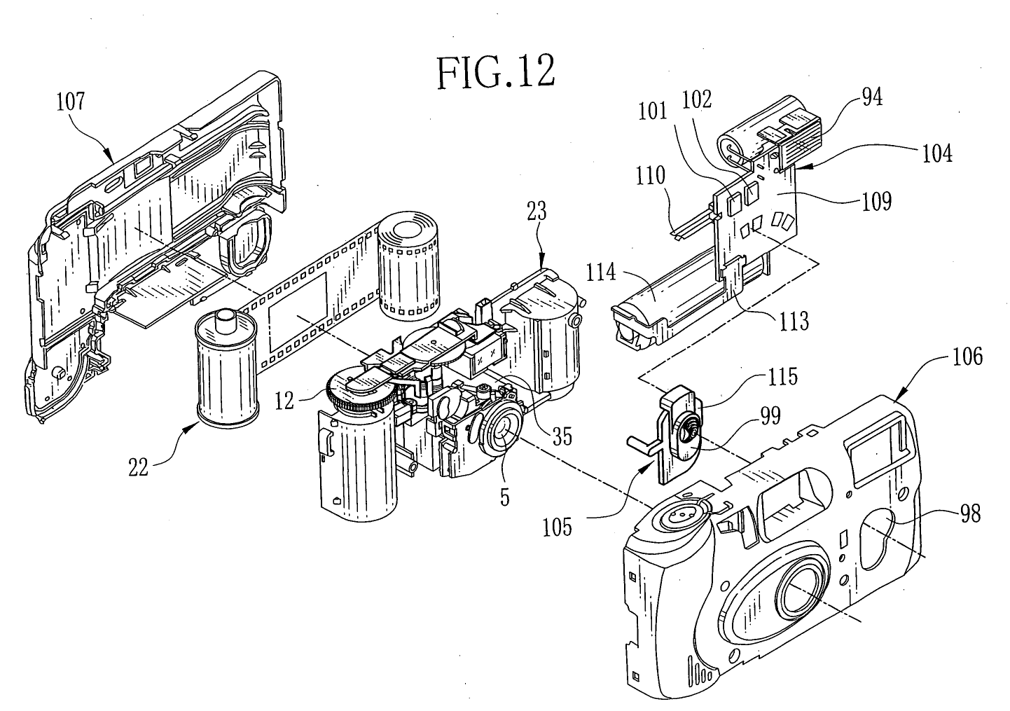

As shown in FIG. 10, the lens-fitted photographic film unit 92 comprises a unit body 93 having a variety of taking mechanisms integrated therein, a film cartridge 22 (see FIG. 12) preloaded in the unit body 93 at the time of manufacture, and the label 4 attached around the unit body 93.

The front face of the unit body 93 is provided with the taking lens 5, the viewfinder 6, a flash light emitting portion 94, and a mode selection portion 95. The top face of the unit body 93 is provided with the shutter release button 9, the counter display window 10, a charging condition indicator 96, and a mode indicator 97.

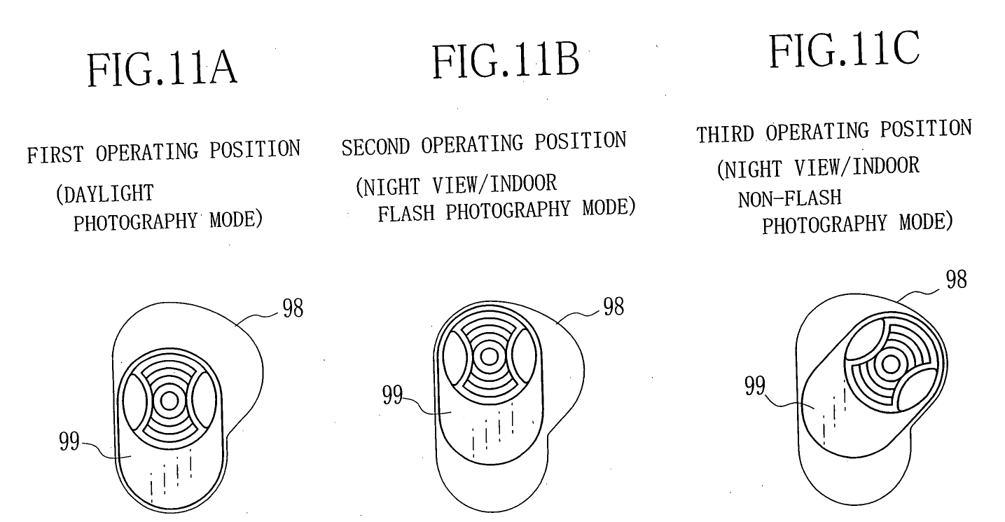

As shown in FIG. 11A to FIG. 11C, the mode selection portion 95 comprises an operation slit 98 formed on the front face of the unit body 3, and a mode selection lever 99 in the shape of an ellipse that is movable within the operation slit 98. The mode selection lever 99 is movable from a first operating position at the bottom within the operation opening 98 (see FIG. 11A) to a third operating position (see FIG. 11C) in a clockwise rotated position from a second operating position, via the second operating position above the first operating position (see FIG. 11B).

When the mode selection lever 99 is in the first operating position, the lens-fitted photographic film unit 2 is in a normal mode, which is the daylight photography mode (the first photography mode) for using the small aperture and the high speed shutter and turning the flash off. When the mode selection lever 99 is in the second operating position, a night view/indoor flash photography mode (the second photography mode) is selected for using the large aperture and the low speed shutter and turning the flash device on. When the flash completes charging in the second photography mode, the light from a light emitting element 101 behind the charging condition indicator 96 is guided by a light guide (not shown) to the charging condition indicator 96.

When the mode selection lever 99 is in the third operating position, a night view/indoor non-flash photography mode (a third photography mode) is selected for using the large aperture and the low speed shutter and turning the flash off. A light emitting element for mode indicator 102 behind the mode indicator 97 blinks when shutter release is performed in the third photography. A lamp or a neon bulb can be employed instead of the light emitting element.

As shown in FIG. 12, the unit body 93 comprises the body base 23, a flash unit 104 mounted on the front face of the body base 23, a mode changeover mechanism 105 for changing the photography mode, and a front cover 106 and the rear cover 107 attached to the front side and the rear side of the body base 23, respectively.

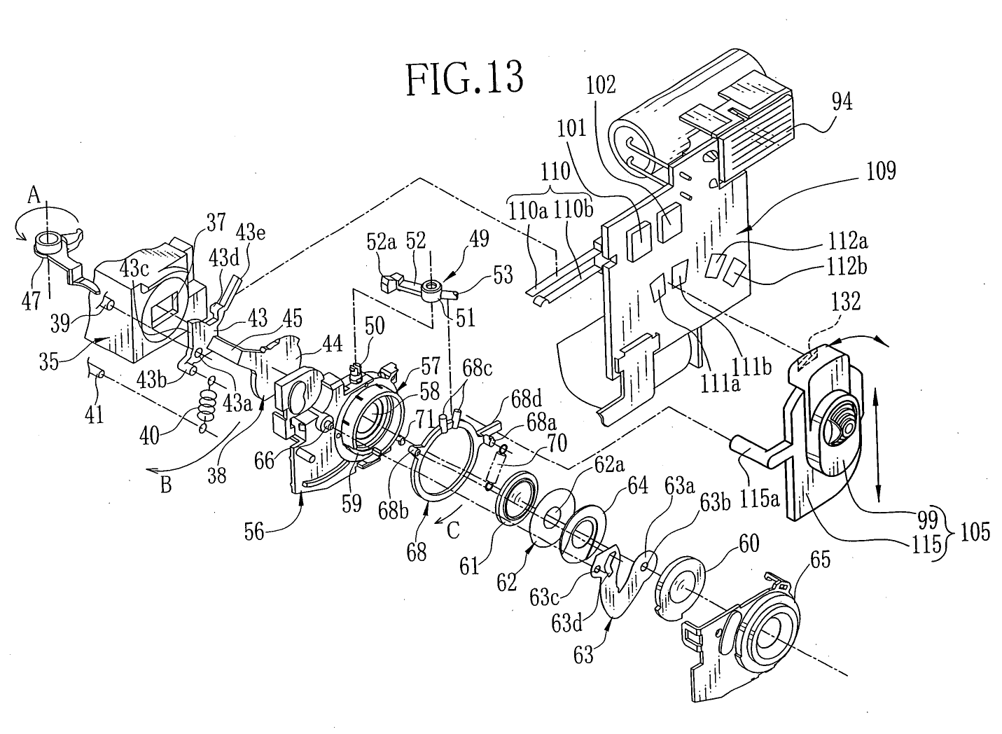

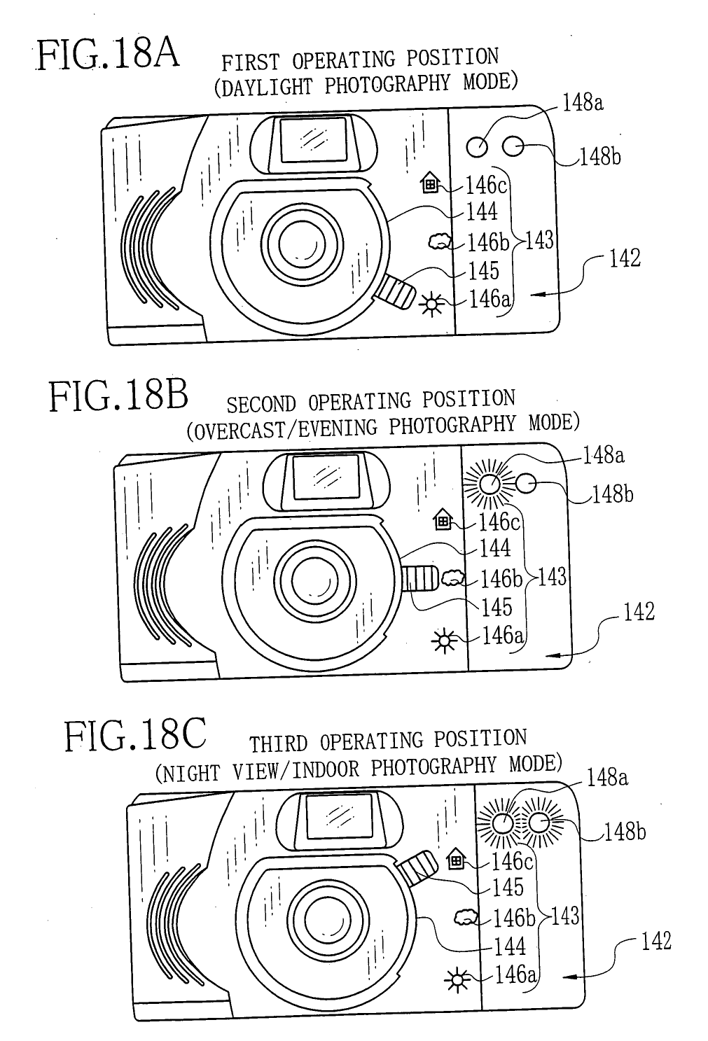

The flash unit 104 comprises a circuit board 109 having a variety of electric components attached thereto, a flash circuit 121 and a light emitting circuit 122 (see FIG. 18), and the flash light emitting portion 94 that includes a discharge tube, a reflector, and a light diffusion plate. Attached to the circuit board 109 are a sync switch 110 to be turned on in response to the shutter release for emitting the flash light, contacts 111a, 111b, 112a, and 112b (see FIG. 13) that constitute switches to be turned on/off by the move of the mode selection lever 99, a battery contact 113 for connecting a battery 114 to the flash circuit 121, the light emitting element for charging condition indicator 101, and the light emitting element for mode indicator 102. The sync switch 110 comprises a pair of metal contacts 110a and 110b and is turned on when kicked by the shutter blade 38 swinging to the opening position.

The light-shielding tunnel 35 is provided at the front center of the body base 23. The vicinity of the light-shielding tunnel 35 is provided with the shutter charge mechanism, the shutter release mechanism, the film winding mechanism, the film winding stop mechanism, the frame count mechanism, the stop changeover mechanism, the shutter speed changeover mechanism, the imaging optical system, and the finder optical system. The shutter release mechanism and the imaging optical system have the same composition as those in the above-stated first embodiment, and the stop changeover mechanism and the shutter aped changeover mechanism have almost the same compositions as those in the first embodiment.

As shown in FIG. 13, the mode changeover mechanism 105 comprises the mode selection lever 99 and a slide plate 115. The slide plate 115 is disposed between the circuit board 109 and the front cover 106, while the mode selection lever 99 is supported on the slide plate 115. The slide plate 115 is slidable between the first operating position and the second operating position relative to the circuit board 109, and the mode selection lever 99 is rotatable between the second operating position and the third operating position relative to the slide plate 115.

The changeover ring 68 constituting the stop changeover mechanism and the shutter speed changeover mechanism swings when the pin 68d is kicked by the press pin 115a integrally formed with the slide plate 115. When the mode selection lever 99 moves from the first operating position to the second operating position, the slide plate 115 moves together with the mode selection lever 99 and the press pin 115a pushes up the pin 68d. The aperture and the shutter speed are thus changed.

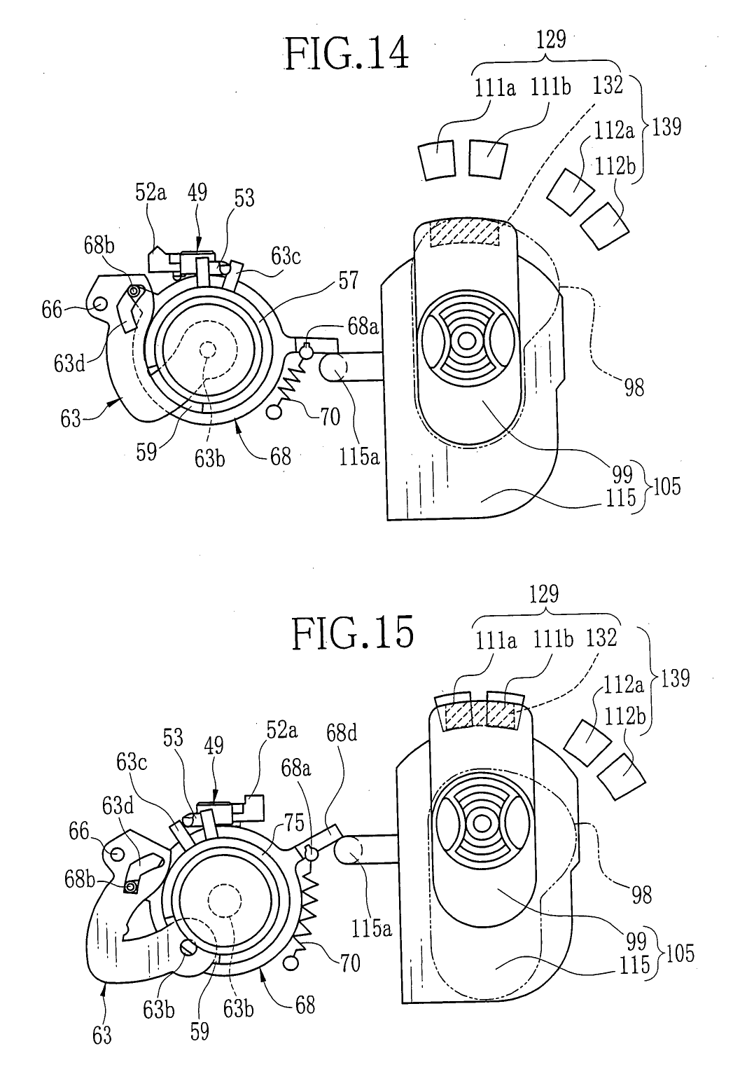

As shown in FIG. 14, in the first photography mode the changeover ring 68 is held in the primary position, since the press pin 115a of the slide plate 115 does not contact the pin 68d. Accordingly, the small aperture stop portion 63a is set on the photography optical axis and the stop lever 49 is set in the high speed shutter position. As shown in FIG. 15, when the photography mode is changed from the first photography mode to the second photography mode, the slide plate 115 moves together with the mode selection lever 99 moving from the first operating position to the second operating position, and thus the press pin 115a pushes up the pin 68d against the bias of the spring 70 to rotate the changeover ring 68 counterclockwise. Accordingly, in the second photography mode the small aperture stop portion 63a moves away and the stop lever 49 is set in the low speed shutter position.

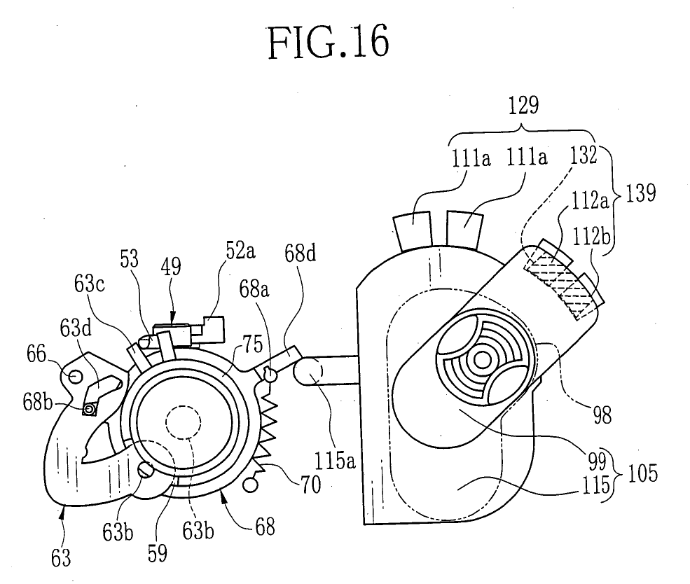

When the photography mode is changed from the second photography mode to the third photography mode as shown in FIG. 16, the aperture and the shutter speed are not changed because the slide plate 115 does not move while the mode selection lever 99 moves from the second operating position to the third operating position.

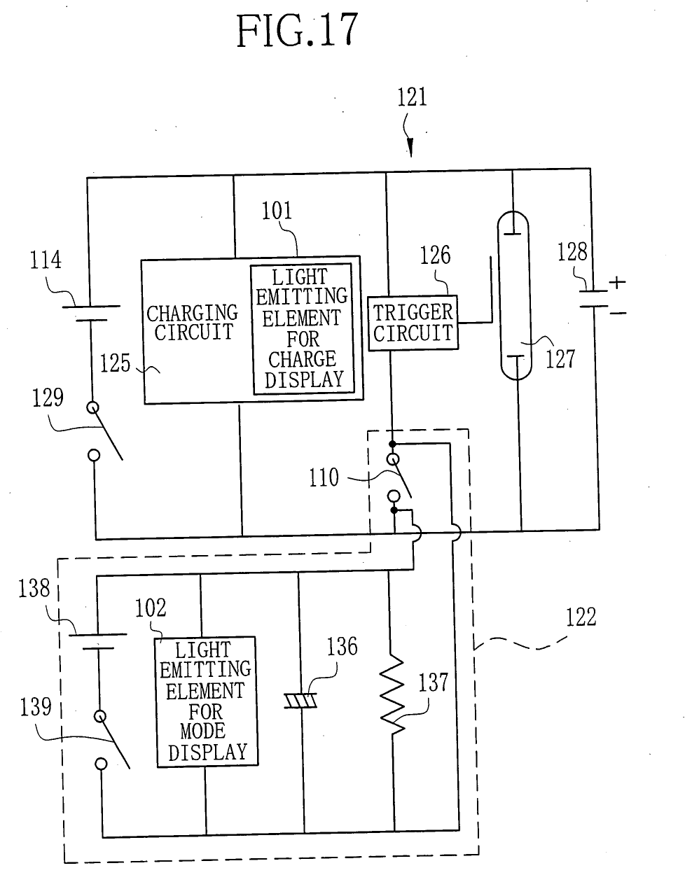

As shown in FIG. 17, the flash circuit 121 comprises a charging circuit 125, a trigger circuit 126, a discharge tube 127, a main capacitor 128, a charging switch 129, the sync switch 110, and the power source battery 114. When the charging switch 129 is turned on, the charging circuit 125 is activated to change the main capacitor 130. When the main capacitor 128 completes to be charged, the light emitting element for charging completion indicator 101 lights up. In this state when the sync switch 110 is turned, the trigger circuit 126 is activated and sends out a trigger signal. With the trigger signal, the electric charge in the main capacitor 128 is discharged and the discharge tube 127 emits the light. Note that the charging switch 129, as shown in FIG. 14 to FIG. 16, comprises the contacts 111a and 111b, and a contact portion 132 which is formed on the rear surface of the mode selection lever 99 to face the contacts 111a and 111b. As shown in FIG. 14, when the mode selection lever 99 is in the first operating position, the contact portion 132 does not contact the contacts 111a and 111b. As shown in FIG. 15, when the mode selection lever 99 moves from the first operating position to the second operating position, the contact portion 132 contacts the contacts 111a and 111b to turn on the charging switch 129. Accordingly, the flash device is turned on to emit in response to the shutter release in the second photography mode. As shown in FIG. 16, when the mode selection lever 99 moves from the second operating position to the third operating position, the flash device is turned off because the contact portion 132 does not contact the contacts 111a and 111b.

The light emitting circuit 122 has the same composition as that in the above-stated first embodiment and comprises a condenser 136, a load resistance 137, a power source battery 138, the light emitting element for mode indicator 102, a switch 139, and the sync switch 110. As shown in FIG. 14 to FIG. 16, the switch 139 comprises the contacts 112a and 112b formed on the circuit board 109, and the contact portion 132 formed on the rear surface of the mode selection lever 99. As shown in FIG. 14 or 15, when the mode selection lever 99 is in the first operating position or the second operating position, the switch 139 is in the OFF state because the contact portion 132 does not contact the contacts 112a and 112b. When the mode selection lever 99 moves from the second operating position to the third operating position, the contact portion 132 contacts the contacts 112a and 112b to turn on the light switch 139. The light emitting element for mode indicator 102 blinks when as the sync switch 110 is turned on by the shutter blade 38 swinging to the opening position.

It is possible to provide a fourth photography mode between the second photography mode and the third photography mode. In the fourth photography mode, the flash device does not emit the light. In order to discriminate between the third photography mode and the fourth photography mode, the indication of the light emitting element for mode indicator 102 takes different patterns in those photography modes.

The condition in each photography mode of the lens-fitted photographic film unit of the present embodiment is shown in the following Table 1.

TABLE 1

| | | | Night View/ |
|---|---|---|---|
| | | Night view/ | Indoor |
| | Daylight | Indoor Flash | Non-flash |
| | Photography | Photography | Photography |
| | Mode | Mode | Mode |
| Diaphragm Value | 16 | 4.6 | 4.6 |
| (f) | | | |
| Shutter Speed | 1/100 | 1/45 | 1/45 |
| (second) | | | |
| Flash Light GN | Non-flash | Flash | Non-flash |
| (Guide Number) | — | 2 | — |
| Correct Exposure | 10 | 5.2 | 5.2 |
| Value(LV) | | | |
| Charge/Mode | NO | Charging- | Mode |
| Indication | Charging | completion | Indication |
| | | Lighting-up | Blink |

The following description explains the operation of the above composition. In order to photograph in the bright place such as under daylight, the photographing is performed after the mode selection lever is set in the first operating position to select the first photography mode (the daylight photography mode). The small aperture stop plate 63 is thus set on the photography optical axis and the stop lever 49 is set in the high speed shutter position. Since the charging switch 129 and the switch 139 are in the OFF state, the flash circuit 121 and the light emitting circuit 122 are in the OFF state as well. When the release button 9 is pressed down in the first photography mode, the photographing is performed with the diaphragm value at f16 and the shutter speed at 1/100 without emitting the flashlight. It is possible for the photographer or the subject person to know that the photographing has been performed in the first photography mode because neither the light emitting element for mode indicator 102 nor the flash device emits the light.

On the other hand, in order to photograph at nighttime or in a dark place such as the indoor place, the second photography mode (the night view/indoor flash photography mode) is selected by setting the mode selection lever 99 in the second operating position. When the mode selection lever 99 moves from the first operating position to the second operating position, the stop changeover plate 63 moves away from the photography optical axis and the stop lever 49 is set in the low speed shutter position. In addition, the charging switch 129 is turned on to start charging the flash circuit 121. When the release button 9 is depressed in the second photography mode, the photographing is performed with the diaphragm value at f4.6, the shutter speed at 1/45, and the flashlight. Since the light switch 139 is in the OFF state, the light emitting element for mode indicator 102 does not emit the light.

In order to photograph at nighttime or lighted indoor place, the third photography mode (the night view/indoor non-flash photography mode) is selected by setting the mode selection lever 99 in the third operating position. When the mode selection lever 99 moves from the second operating position to the third operating position, the stop changeover plate 63 and the stop lever 49 keeps their positions in the second photography mode but the charging switch 129 is turned off. ON the other hand, the light switch 139 is turned on and light emitting element for mode indicator 102 emits the light. When the release button 9 is depressed in the third photography mode, the photographing is performed with the diaphragm value at f4.6 and the shutter speed at 1/45 without the flashlight. On shutter release the sync switch 110 is turned on, and the light emitting element for mode indicator 102 blinks. Accordingly, it is possible for the photographer or the subject person to know that the photographing has been performed in the third photography mode.

Accordingly, it is possible to prevent the user from unknowing to have been photographing in a wrong photography mode, by blinking the light emitting element for mode indicator 102 when a non-normal photography mode without flashlight has been selected. Moreover, it can prompt the user to return the photography mode to the normal photography mode, by letting the user be aware of that the photographing has been performed in the non-normal photography mode.

Although there provided is only the night view/indoor photography mode as the non-normal photography mode in the lens-fitted photographic film unit without the flash device as shown in FIG. 1 and FIG. 2, it is also possible to provide other photography modes. For example, as shown in FIG. 18, a lens-fitted photographic film unit 142 has no flash device and is provided with a mode selection portion 143 for changing the photography mode among three different modes. The mode selection portion 143 comprises a slit 144 in the shape of an arc, a mode selection lever 145 for moving within the slit 144, and indicia 146a 146b, and 146c provided near the slit 144. The photography mode is selected by setting the mode selection lever 145 to one of the indicia 146a, 146b, and 146c. The condition in each photography mode of the lens-fitted photographic film unit 142 is shown in the following Table 2.

TABLE 2

| | | Overcast/ | Night View/ |
|---|---|---|---|
| | Daylight | Evening | Indoor |
| | Photography | Photography | Photography |
| | Mode | Mode | Mode |
| Diaphragm Value | 16 | 5.6 | 4.6 |
| (f) | | | |
| Shutter Speed | 1/100 | 1/100 | 1/45 |
| (second) | | | |
| Correct Exposure | 10 | 7.0 | 5.2 |
| Value(LV) | | | |

The stop changeover mechanism and the shutter speed changeover mechanism in the lens-fitted photographic film unit 142 are approximately the same as those in the above first and the second embodiment.

As shown in FIG. 18A to FIG. 18C, the lens-fitted photographic film unit 142 is provided with mode indicators 148a and 148b for indicating the selected photography mode. Each of the mode indicators 148a and 148b is provided with a light emitting element behind thereof which is turned on/off in accordance with the operation of the mode selection lever 145. As shown in FIG. 18A, when the first photography mode (the daylight photography mode indicated by the indicium 146c) is selected, neither the mode indicators 148a nor 148b emits the light, while the mode indicator 148a alone blinks when the second photography mode (the overcast/evening photography mode) is selected, as shown in FIG. 18B. As shown in FIG. 18C, when the third photography mode (the night view/indoor photography mode) is selected, both of the mode indicators 148a and 148b blinks. Since the number of the mode indicator to blink is different in each photography mode, it is possible for the user to know the selected photography mode not to photograph in a wrong photography mode.

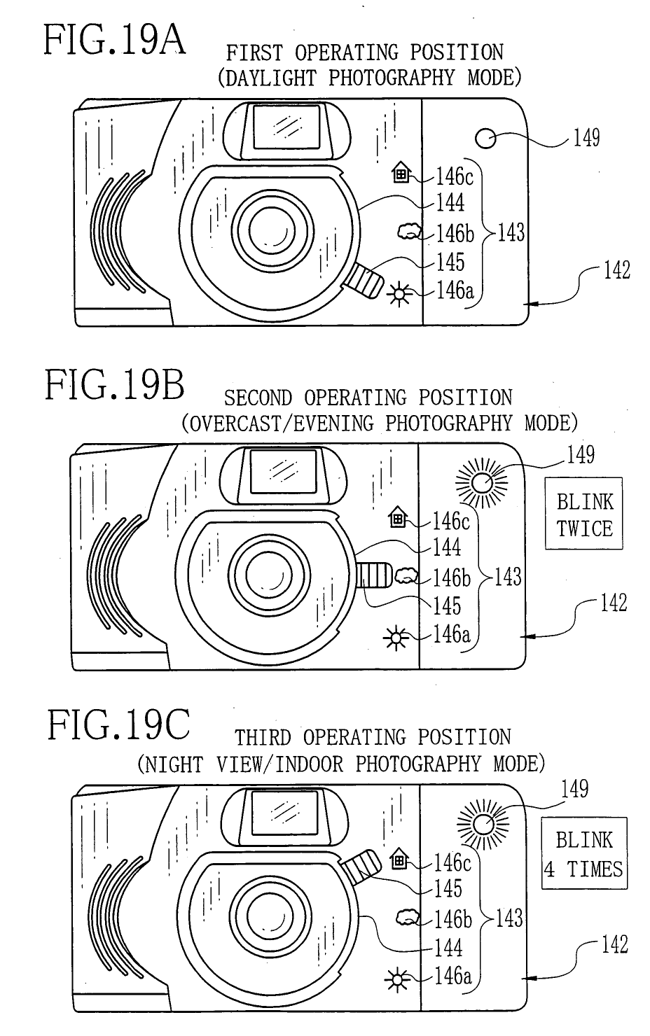

It is also possible to provide the lens-fitted photographic film unit 142 with only a single mode indicator to change the number or the period of blink of the light emitting element in accordance with the selected photography mode. In this case, for example, the mode indicator 149 does not emit the light as shown in FIG. 19A when the first photography mode (the daylight photography mode) is selected, blinks twice as shown in FIG. 19B when the second photography mode (the overcast/evening photography mode) is selected, and blinks four times as shown in FIG. 19C when the third photography mode (the night view/indoor photography mode) is selected.

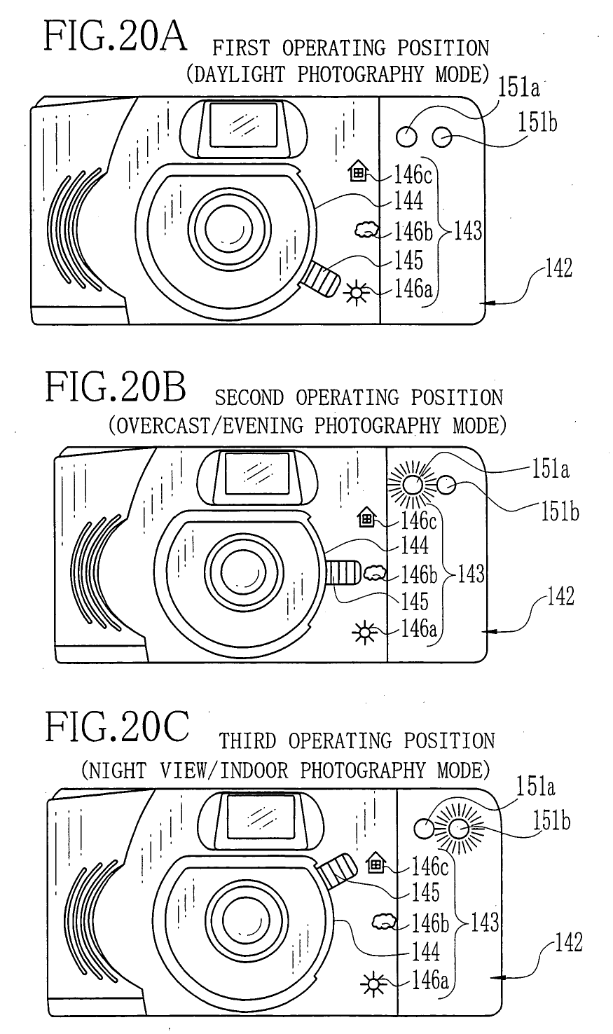

Alternatively, it is possible to provide a plurality of mode indicators 151a and 151b that emit the light in different colors, as shown in FIG. 20A to FIG. 20C. In this case, for example, a light emitting element for illuminating green light and a light emitting element for illuminating orange light are provided behind the mode indicators 151a and 151b, respectively. When the first photography mode (the daylight photography mode) is selected, neither mode indicators 151a nor 151b emit the light as shown in FIG. 20A, while the mode indicator 151a for emitting the green light blinks, as shown in FIG. 20B, when the second photography mode (the overcast/evening photography mode) is selected, and the mode indicator 151b for emitting the orange light blinks, as shown in FIG. 20C, when the third photography (the night view/indoor photography mode) is selected. For easy discrimination to the user, it is preferred to arrange the number of blink time is also different in the second photography mode and the third photography mode.

Moreover, it is possible to arrange such that the mode indicator emits the light on selection of the photography mode and starts blinking on shutter release. This can call the user's attention to the selected photography mode by both emission and blink of the light.

Furthermore, although the mode indicator is disposed on the top face of the front face of the lens-fitted photographic film unit, it is preferred to provide the mode indicator in a position, such as the side face or the bottom on the lens-fitted photographic film unit, observable from both the photographer and the subject person, or in positions observable from the photographer and the subject person, respectively.

In addition, the present invention is applicable not only to the lens-fitted photographic film unit, as described in the above embodiments, but also to a simple camera whose photo film is removable easily.

Although the present invention has been described with respect to the preferred embodiments, the present invention is not to be limited to the above embodiments but, on the contrary, various modifications will be possible to those skilled in the art without departing from the scope of claims appended hereto.

What is claimed is:

1. A camera including a flash device to be changed between an ON state and an OFF state and an exposure control device to change an exposure amount, said flash device emitting the flash light in said ON state for a flash photographing and not emitting the flash light in said OFF state for a non-flash photographing, said camera comprising:
a mode selection member for selecting one photography mode out of a plurality of photography modes, in accordance with said photography mode said flash device being changed between said ON state and said OFF state and said exposure control device changing said exposure amount, said plurality of photography modes including a first photography mode for said flash photographing and a second photography mode for said non-flash photographing; and
at least one mode indicator blinking on photographing when said second photography mode being selected.

2. A camera defined in claim 1, wherein said exposure control device is provided with a shutter, and said mode indicator blinks in conjunction with an operation of said shutter.

3. A camera defined in claim 2, wherein said mode indicator lights up when said second photography mode is selected.

4. A camera defined in claim 2, wherein said plurality of photography modes further include a third photography mode for said non-flash photographing, said exposure amount in said third photography mode is less than said exposure amount in said second photography mode, said third photography mode is suitable for a normal photographing most frequently used, and said mode indicator does not blink in said third photography mode.

5. A camera defined in claim 4, said normal photographing is the photographing in daylight.

6. A camera defined in claim 2, wherein said plurality of photography modes further include said third photography mode and a fourth photography mode that are for non-flash photographing, said exposure amount is the largest in said second photography mode and the smallest in said fourth photography mode among said second, said third and said four photography modes; and
wherein said mode indicator blinks in discernibly different manners in said second photography mode and in said third photography mode, and does not blinks in said fourth photography mode.

7. A camera defined in claim 6, wherein said mode indicator blinks in different number of times in said second photography mode and in said third photography mode.

8. A camera defined in claim 6, wherein said mode indicator is provided with a plurality of light sources disposed in different positions, and the number of said light sources to blink is different in said second photography mode and in said third photography mode.

9. A camera defined in claim 6, wherein said mode indicator blinks in different colors in said second photography mode and in said third photography mode.

10. A camera defined in claim 1, wherein said mode indicator is disposed in a position observable from both a photographer and a subject person.

11. A camera defined in claim 1, wherein two mode indicators are provided, one of said mode indicators is disposed in a position observable from the photographer and another one of said mode indicators is disposed in the position observable from the subject person.

12. A camera for non-flash photographing having an exposure control device to change an exposure amount, said camera comprising:
a mode selection member for selecting one photography mode out of a plurality of photography modes, said exposure control device changing said exposure amount in accordance with said photography mode, said plurality of photography mode including at least a first photography mode and a second photography mode, said exposure amount in said second photography mode being larger than said exposure amount in said first photography mode; and
at least one mode indicator for lighting up or blinking when said second photography mode being selected.

13. A camera defined in claim 12, wherein said mode indicator lights up when said second photography mode is selected, and blinks on photographing.

14. A camera defined in claim 13, wherein said exposure control device is provided with a shutter, and said mode indicator blinks in conjunction with the operation of said shutter.

15. A camera defined in claim 12, wherein said first photography mode is suitable for the photographing in daylight.

16. A camera defined in claim 12, wherein said plurality of photography modes further include a third photography mode, and said exposure amount in said third photography mode is larger than said exposure amount in said second photography mode; and
wherein said mode indicator blinks in discernibly different manners in said second photography mode and in said third photography mode.

17. A camera defined in claim 16, wherein said mode indicator blinks in different number of times in said second photography mode and in said third photography mode.

18. A camera defined in claim 16, wherein said mode indicator is provided with a plurality of light sources disposed indifferent positions, and the number of said light sources to blink is different in said second photography mode and in said third photography mode.

19. A camera defined in claim 16, wherein said mode indicator blinks in different colors in said second photography mode and in said third photography mode.

20. A camera defined in claim 12, wherein said mode indicator is disposed in a position observable to both a photographer and a subject person.

21. A camera defined in claim 12, wherein two mode indicators are provided, one of said mode indicators is disposed in a position observable from the photographer and another one of said mode indicators is disposed in the position observable from the subject person.
